(19) United States
(12) Patent Application Publication
(10) Pub. No.: US 2015/0134919 A1
(43) Pub. Date: May 14, 2015

(54) INFORMATION PROCESSING APPARATUS AND DATA ACCESS METHOD

(71) Applicant: FUJITSU LIMITED, Kawasaki-shi (JP)

(72) Inventors: Miho Murata, Kawasaki (JP); Toshiaki Saeki, Kawasaki (JP); Hiromichi Kobashi, London (GB)

(21) Appl. No.: 14/533,601

(22) Filed: Nov. 5, 2014

(30) Foreign Application Priority Data
Nov. 14, 2013 (JP) 2013-235974

(51) Int. Cl. G06F 13/16; G06F 12/14; G06F 13/18

(52) U.S. Cl. CPC G06F 13/1663; G06F 13/18; G06F 12/145
USPC 711/151; 711/152

(57) ABSTRACT

A memory includes a plurality of areas corresponding to a plurality of segments of a storage device. An operation unit stores each of generated access instructions in an area corresponding to a segment of an access destination of the access instruction among the plurality of areas. The operation unit loads data of a segment corresponding to at least one area selected from the plurality of areas from the storage device to another area which is different from the plurality of areas on the memory, and executes an access instruction stored in the selected area, for the loaded segment data.

### CROSS-REFERENCE TO RELATED APPLICATION

This application is based upon and claims the benefit of priority of the prior Japanese Patent Application No. 2013-235974, filed on Nov. 14, 2013, the entire contents of which are incorporated herein by reference.

### FIELD

The embodiments discussed herein relate to an information processing apparatus and a data access method.

### BACKGROUND

In recent years, it has become possible to collect and analyze a large amount of data owing to improved hardware performance such as increased speed of operation devices, increased capacity of storage devices, and wider band of network. Analyzing a large amount of data may derive valuable information from the collected data. For example, a shopping site in the Internet may employ a recommendation system that presents recommended items to users. The recommendation system collects logs indicating a user's browsing history or purchasing history from a Web server and analyzes the logs to extract a combination of items in which the same user may be likely to be interested.

Data analysis is realized as a batch process, for example. In such a case, a data analysis system first collects data to be analyzed and accumulates the data in a storage device. Upon collecting sufficient data, the data analysis system starts analysis of the entire data accumulated in the storage device. With such a batch process, the more data is accumulated, the longer time the analysis takes.

As a method of shortening the time taken for analyzing a large amount of data, it is conceivable to divide the data and perform parallel data processing with no mutual dependency using a plurality of computers. In order to aid creation of programs that perform such parallel data processing, there is proposed a framework such as Hadoop. Using a framework for parallel data processing allows a user to create programs without being aware of the details of complicated processes such as communication between computers.

In addition, the time taken for analyzing a large amount of data may vary depending on how storage devices are used. This is because the large amount of data used for analysis is often accumulated in a storage device such as an HDD (Hard Disk Drive), random access to which being relatively slow. Preliminarily sorting the data to be referenced or updated during analysis in the storage device according to the order of reference or updating, may reduce random access, resulting in faster data access. With regard to a method of increasing the efficiency of data access, there is proposed a technique as follows.

For example, there is proposed a data storage device having a magnetic disk and a cache memory and being configured to increase the read access speed by storing, in a cache memory, a part of data stored in the magnetic disk. The data storage device stores the type of received access, such as re-access to the same data or sequential access to adjacent data, and changes the size of area of the cache memory to be used, according to the type of the received access.

In addition, there is proposed a disk storage device having a disk medium and a buffer memory and being configured to reduce the overhead of data write to the disk medium using the buffer memory. Upon receiving a write command of writing data equal to or smaller than a predetermined size to the disk medium, the disk storage device stores the data in the buffer memory. The disk storage device then groups data whose write destination addresses are close together and, when the amount of data belonging to a group exceeds a predetermined amount, writes the data of the group collectively to the disk medium.

Japanese Laid-Open Patent Publication No. 10-301847

Japanese Laid-Open Patent Publication No. 11-317008

The Apache Software Foundation, “Welcome to Apache Hadoop!”, [online], 2012, [retrieved on Jul. 23, 2013], Internet <URL: hadoop.apache.org/index.pdf>

After having once obtained an analysis result, a user of the data analysis system often desires to update the analysis result when the data to be analyzed are added or updated. For example, it is preferred that, upon obtaining a log indicating a new browsing history or purchase history from the Web server, the recommendation system reflects the new browsing history or purchase history in the analysis result.

Updating such an analysis result by a conventional batch process leads to re-analyzing all the accumulated data including the part which has not changed from the previous time. In contrast, there is conceivable a method of updating only the analysis result related to the data to be analyzed which have been added or updated. For example, the recommendation system may recalculate the degree of association between items for a limited combination between newly browsed or purchased items and other items. Such a data processing method may be referred to as incremental data processing.

In incremental data processing, however, which of the data to be analyzed and data of the previous analysis result stored in the storage device will be accessed depends on the newly collected data to be analyzed. Therefore, it is difficult with incremental data processing to preliminarily sort the data on a storage device according to the order of reference or updating and thus random access is likely to occur. Accordingly, there is a problem that the efficiency of accessing data is likely to drop.

Simply executing write commands collectively, which have write destination addresses close to one another, may cause discontinuous writings to the disk medium, and thus there is room for improving the efficiency of data access. In addition, the access efficiency is likely to drop when performing a complicated access instruction which refers to existing data and updates the data, such as, for example, incrementing the number of times an item is browsed or the number of items purchased, based on a new log.

### SUMMARY

According to an aspect, there is provided an information processing apparatus having a storage device including a plurality of segments configured to store data; a memory including a plurality of areas corresponding to the plurality of segments; and a processor configured to process a plurality of generated access instructions, the processor being configured to: store each of the generated access instructions in an area corresponding to a segment of an access destination of the access instruction among the plurality of areas on the memory; and load data of a segment corresponding to at least one area selected from the plurality of areas on the memory from the storage device to another area which is different from the plurality of areas on the memory, and execute the access instruction stored in the selected area, for the loaded data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an information processing apparatus of a first embodiment;

FIG. 2 illustrates an exemplary information processing system of a second embodiment;

FIG. 3 illustrates an example of performing data analysis as a batch process;

FIG. 4 illustrates an example of performing data analysis as an incremental process;

FIG. 5 is a block diagram illustrating exemplary hardware of a server apparatus;

FIG. 6 is a block diagram illustrating an exemplary function of the server apparatus;

FIG. 7 illustrates an exemplary entire instruction queue;

FIG. 8 illustrates an exemplary key information table;

FIG. 9 illustrates an exemplary cache management queue;

FIG. 10 illustrates an example of allocating access instructions to per-segment instruction queues;

FIG. 11 illustrates an example of calculating the number of segments to be cached;

FIG. 12 illustrates an example of performing an access instruction;

FIG. 13 is a flowchart illustrating an exemplary procedure of generating an access instruction;

FIG. 14 is a flowchart illustrating an exemplary procedure of allocating access instructions;

FIG. 15 is a flowchart illustrating an exemplary procedure of executing an access instruction; and

FIG. 16 is a flowchart illustrating an exemplary procedure of executing an access instruction (continued).

### DESCRIPTION OF EMBODIMENTS

Several embodiments will be described below with reference to the accompanying drawings, wherein like reference numerals refer to like elements throughout.

### First Embodiment

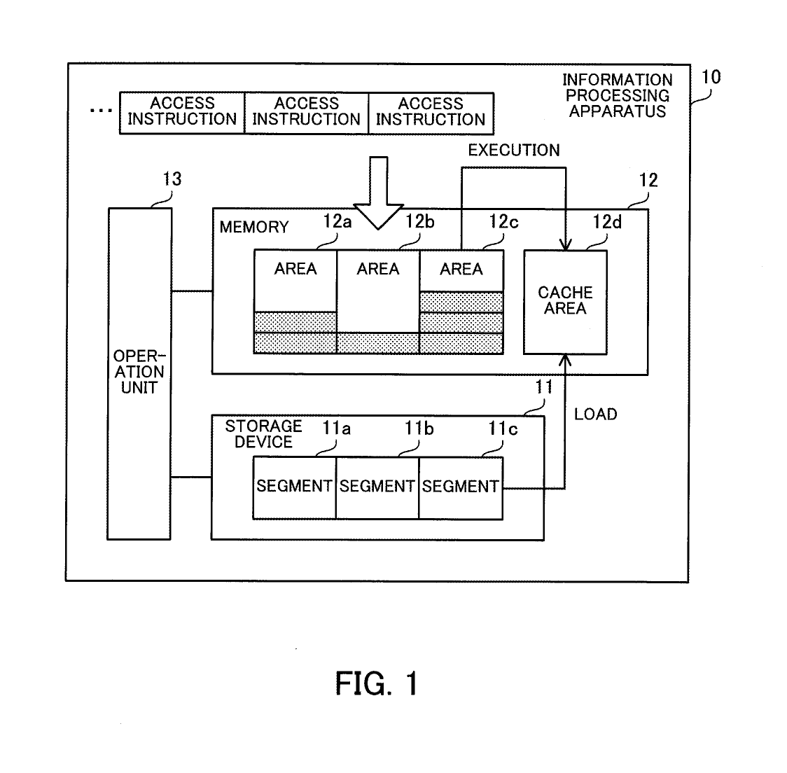

FIG. 1 illustrates an information processing apparatus of a first embodiment.

An information processing apparatus 10 has a storage device 11, a memory 12, and an operation unit 13. The storage device 11, random access to which being slower than to the memory 12, is a nonvolatile storage device which uses a disk medium such as an HDD, for example. The memory 12, random access to which being faster than to the storage device 11, is a volatile or nonvolatile semiconductor memory such as a RAM (Random Access Memory), for example. The operation unit 13 is, for example, a processor. The processor may be a CPU (Central Processing Unit) or a DSP (Digital Signal Processor), and may include an integrated circuit such as an ASIC (Application Specific Integrated Circuit) or an FPGA (Field Programmable Gate Array). The processor executes a program stored in the memory 12, for example. In addition, the “processor” may be a set (multiprocessor) of two or more processors.

The storage device 11 includes segments 11a, 11b and 11c storing data. The sizes of the segments 11a, 11b, and 11c may be all the same, or may be different. Respective data elements stored in the segments 11a, 11b and 11c are identified by keys, for example. In that case, the correspondence relation between segments and keys has been defined. For example, the relation is defined such that data elements for keys A and B are stored in the segment 11a, data elements for keys C and D are stored in the segment 11b, and data elements for keys E and F are stored in the segment 11c. The correspondence relation between keys and segments may be automatically determined, or manually determined by the user.

The memory 12 includes areas 12a, 12b and 12c, and a cache area 12d. The areas 12a, 12b and 12c correspond to the segments 11a, 11b and 11c on a one-to-one basis. The area 12a corresponds to the segment 11a, the area 12b corresponds to the segment 11b, and the area 12c corresponds to the segment 11c. The areas 12a, 12b and 12c temporarily store an access instruction described below before execution. According to the control by the operation unit 13, the cache area 12d caches data of one or two or more segments included in the storage device 11. The size of the cache area 12d has been predefined considering, for example, capacity of the memory 12, size per segment, number of segments included in the storage device 11, and the like.

The operation unit 13 processes a plurality of access instructions generated due to arrival of data. The access instruction, indicating a request of accessing the data stored in the storage device 11, includes a key identifying data of the access destination, for example. Each access instruction may be a simple read instruction or write instruction. In addition, each access instruction may be an instruction accompanying operation and one-time data read or write, such as an update instruction or a comparison instruction by which the updated value is determined based on the current value. Access instructions are generated at different timings as appropriate. The operation unit 13 may receive an access instruction from another information processing apparatus as appropriate, or may generate one or two or more instructions based on data received, as appropriate, from another information processing apparatus. As a latter case, there may be a case of updating, based on new data, existing data related to the new data.

Here, upon generation of an access instruction, the operation unit 13 stores the access instruction in one of the areas 12a, 12b and 12c on the memory 12 instead of immediately executing the access instruction. The area which stores the access instruction is determined according to the data of the access destination indicated by the access instruction. For example, when a key is included in the access instruction, the operation unit 13 determines an area corresponding to the segment to which the data of the access destination belongs, among the areas 12a, 12b and 12c, based on the correspondence relation between keys and the segments.

As access instructions are accumulated in the areas 12a, 12b and 12c in the aforementioned manner, the operation unit 13 selects one or two or more areas which are a part of the areas 12a, 12b and 12c. One or two or more areas are selected at a time, and the area selection is performed repeatedly. The timing of selecting an area may be a timing according to a predetermined cycle, or may be a timing when the following processing in the area selected previously is completed. In addition, the timing of selecting an area may depend on the amount of access instructions accumulated in the areas 12a, 12b and 12c.

Preferably, the operation unit 13 preferentially selects an area having the largest amount of stored access instructions, from among the areas 12a, 12b and 12c. In addition, when selecting a plurality of areas at a time, the operation unit 13 preferably selects a plurality of areas corresponding to a plurality of adjacent segments in the storage device 11. For example, it is assumed that the segment 11a and the segment 11b are adjacent, and the segment 11b and the segment 11c are adjacent. When selecting two areas, preferably, the operation unit 13 either selects the areas 12a and 12b or selects the areas 12b and 12c, avoiding selection of the areas 12a and 12c.

When one or two or more areas are selected, the operation unit 13 loads the data of the segment corresponding to the selected area from the storage device 11 to the cache area 12d on the memory 12. On this occasion, it is expected that the storage device 11 is capable of reading the entire data of target segments by sequential access. Even when a plurality of areas is selected by the operation unit 13, the storage device 11 is capable of reading data by sequential access provided that the plurality of areas corresponds to the adjacent segments.

The operation unit 13 then executes an access instruction (usually, a plurality of access instructions) stored in the selected area for the data loaded to the cache area 12d. For example, the operation unit 13 selects the area 12c, and loads the entire data of the segment 11c to the cache area 12d. The operation unit 13 then executes the access instruction of the area 12c for the cached data. An access instruction whose execution has been completed may be deleted from the selected area. After having executed all the access instructions in the selected area, the operation unit 13 may write back the data of the cache area 12d to the original segment. On this occasion, the storage device 11 is expected to be capable of writing the entire data by sequential access.

According to the information processing apparatus 10 of the first embodiment, the plurality of access instructions is not executed in the order of generation, but is allocated for and stored in the areas 12a, 12b and 12c provided on the memory 12 in association with the segments 11a, 11b and 11c. Data of one or two or more segments are then loaded from the storage device 11 to the memory 12, and access instructions accumulated in the area corresponding to the segment are collectively executed for the loaded data.

Accordingly, when collectively executing access instructions for one or two or more segments, data access is sequentially performed in the storage device 11. For example, each time one or two or more areas on the memory 12 are selected once, it suffices that the storage device 11 performs at most one sequential read and at most one sequential write. Therefore, it is possible to suppress drop of access efficiency due to occurrence of random access. In addition, access instructions are executed for data of segments cached on the memory 12 to which random access is relatively fast, and therefore it is also possible to effectively execute an access instruction accompanying operation and one-time data read and write.

The more the number of areas selected by the operation unit 13 at a time is increased, in other words, the more the number of segments of data to be collectively loaded is increased, the more the number of times of sequential access performed by the storage device 11 during a certain time may be reduced. Therefore, the more the number of areas selected at a time is increased, the smaller the overhead of data access by the storage device 11 becomes, and it is possible to increase the number of access instructions (throughput) to be processed during a certain time. The operation unit 13 may adjust the number of areas selected at a time, according to the number of generation of access instructions per unit time.

### Second Embodiment

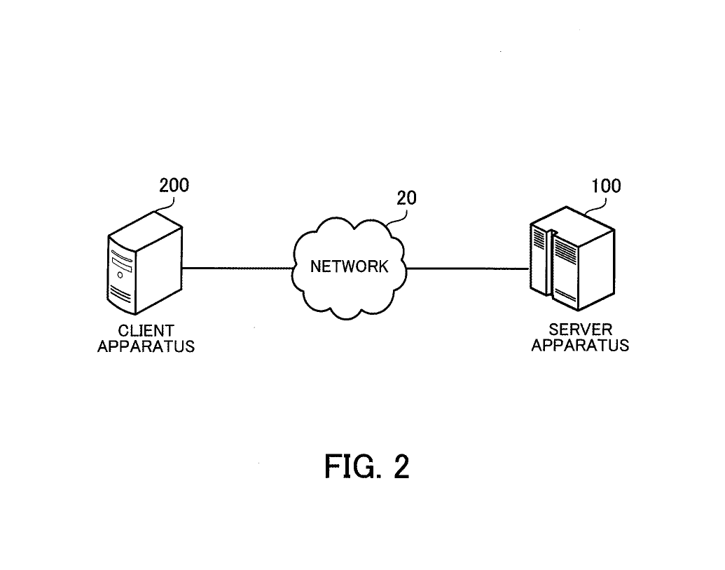

FIG. 2 illustrates an exemplary information processing system of a second embodiment. The information processing system of the second embodiment is a recommendation system which presents information of items recommended to a user. In addition, the information processing system of the second embodiment has a function as an Internet shopping site. In the following, “shopping site” means a shopping site on the Internet which uses the information processing system of the second embodiment.

The information processing system of the second embodiment has a server apparatus 100 and a client apparatus 200. The server apparatus 100 is an example of the information processing apparatus 10 of the first embodiment. The server apparatus 100 is connected to the client apparatus 200 via a network 20. There may be a plurality of server apparatuses 100.

The server apparatus 100 is a server computer configured to analyze a recommended item. The server apparatus 100 receives purchase history information of a user using a shopping site from the client apparatus 200 regularly or irregularly, and accumulates the received purchase history information. When sufficient purchase history information has been accumulated for analysis, the server apparatus 100 performs a first-time analysis procedure as a batch process for the accumulated entire purchase history information. Subsequently, the server apparatus 100 performs a second-time or later analysis procedure of the purchase history information regularly or irregularly as an incremental process. The incremental process refers to processing only the purchase history information and information related thereto which have been newly received after the previous processing. In addition, the server apparatus 100 transmits information indicating the analysis result to the client apparatus 200.

The client apparatus 200 is a client computer configured to transmit purchase history information to the server apparatus 100 regularly or irregularly. In addition, the client apparatus 200 has a function as a Web server which provides a shopping site service to a user. The client apparatus 200 transmits a user's purchase history information of an item to the server apparatus 100 regularly or irregularly. The client apparatus 200 receives information indicating the analysis result of the purchase history information from the server apparatus 100. In addition, the client apparatus 200 generates information related to a recommended item based on information indicating the received analysis result, and provides the user with the generated information. The information related to the recommended item may be provided to the user via a shopping site, for example, or may be provided to the user by e-mail or the like.

The analysis result of the purchase history information provided by the server apparatus 100 includes the degree of similarity between any two items. The degree of similarity indicates the probability that the same user is interested in both of the two items. For example, the client apparatus 200 identifies an item purchased in the past by a user who has accessed the client apparatus 200, and recommends, to the user, another item having a high degree of similarity with the item purchased in the past. In addition, for example, the client apparatus 200 identifies an item currently being browsed by a user, and recommends, to the user, another item having a high degree of similarity with the item being browsed.

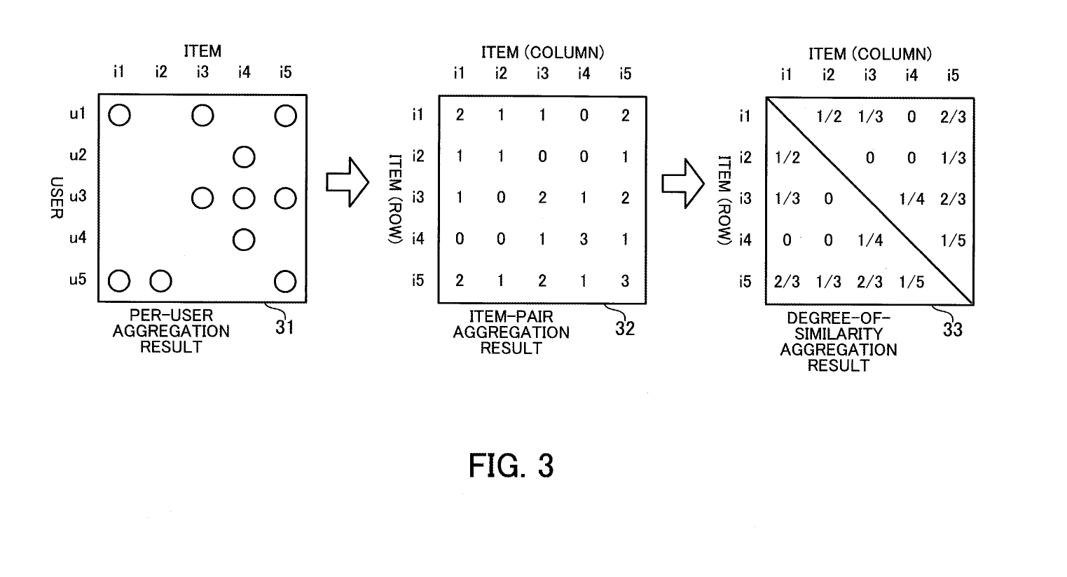

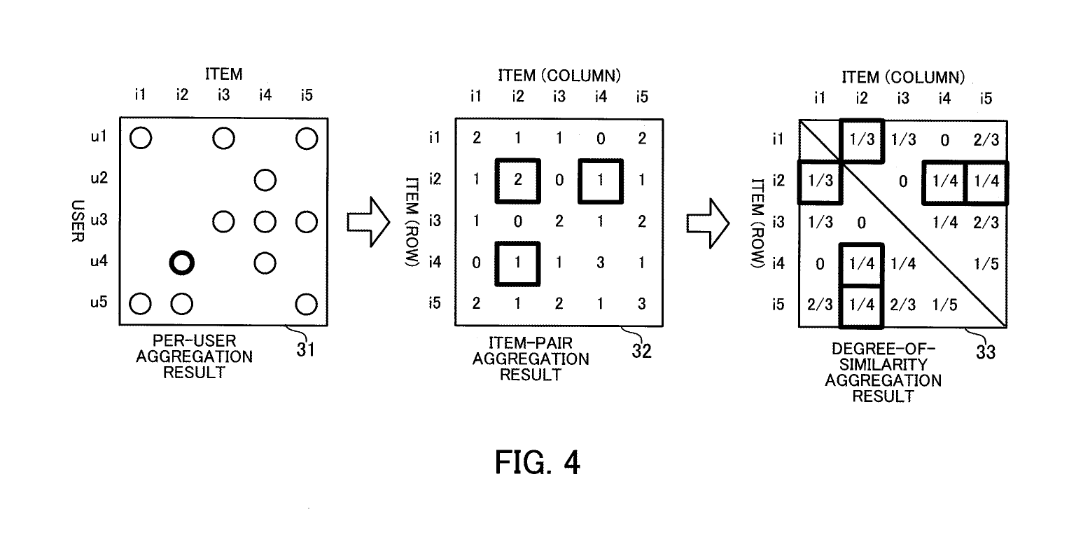

Next, an example of analyzing purchase history information at a shopping site by the server apparatus 100 will be described, referring to FIGS. 3 and 4. It is assumed in the system of the second embodiment that the time from the start to the end of analysis does not matter, and may take several minutes or several tens of minutes.

FIG. 3 illustrates an example of performing data analysis as a batch process. In FIG. 3, there is described a method of performing an analysis procedure by the server apparatus 100 as a batch process on purchase history information which has been accumulated for a certain period. The server apparatus 100 analyzes the accumulated purchase history information as follows.

First, the server apparatus 100 generates a per-user aggregation result 31 from the accumulated purchase history information. The per-user aggregation result 31 is a matrix indicating the result of aggregating, for each item purchasable at the shopping site, whether or not the item is purchased by each user within a certain period. Each row of the per-user aggregation result 31 represents a user at the shopping site, and each column of the per-user aggregation result 31 represents an item purchasable at the shopping site. Each component of the per-user aggregation result 31 represents whether or not a user has purchased an item within a certain period. The component is marked with “∘” (or “1”) when a user has purchased an item, whereas the component is marked with a blank (or “0”) when the user has not purchased an item. The per-user aggregation result 31 is generally a sparse matrix with a low density of “∘”. In the following, a component in the per-user aggregation result 31 corresponding to a row representing a user and a column representing an item may be referred to as a “purchase-flag (user, item)”.

For example, let us assume that a user u1 has purchased items i1, i3 and i5, and a user u2 has purchased an item i4 within a certain period. In addition, let us assume that a user u3 has purchased the items i3, i4 and i5, a user u4 has purchased the item i4, and a user u5 has purchased the items i1, i2 and i5. In this case, the purchase-flag (user u1, item i1), the purchase-flag (user u1, item i3), the purchase-flag (user u1, item i5), and the purchase-flag (user u2, item i4) are “0”, as indicated by the per-user aggregation result 31 of FIG. 3.

In addition, the purchase-flag (user u3, item i3), the purchase-flag (user u3, item i4), the purchase-flag (user u3, item i5), and the purchase-flag (user u4, item i4) are “∘”. Furthermore, the purchase-flag (user u5, item i1), the purchase-flag (user u5, item i2), and the purchase-flag (user u5, item i5) are “∘”. In addition, the components other than those described above in the per-user aggregation result 31 are left as blanks.

Next, the server apparatus 100 generates an item-pair aggregation result 32 from the per-user aggregation result 31. The item-pair aggregation result 32 is a symmetric matrix indicating, for a pair of items (combination of any two items) purchasable at the shopping site, the result of summing the number of users who have purchased both items within a certain period. Each row and each column of the item-pair aggregation result 32 represent an item purchasable at the shopping site. Each component of the item-pair aggregation result 32 represents the number of users who have purchased both of the two items within a certain period. In the following, a component corresponding to a pair of items in the item-pair aggregation result 32 may be referred to as “number-of-users (item (row), item (column))”. A diagonal component corresponding to a set of identical items (e.g., number of users (item i1, item i1)) represents the number of users who have purchased the item.

For example, there are two users, namely users u1 and u5, who have purchased the item i1 as indicated by the per-user aggregation result 31 of FIG. 3. Accordingly, the number-of-users (item i1, item i1) is two, as indicated by the item-pair aggregation result 32 of FIG. 3. In addition, there is one user, namely user u5, who has purchased the item i1 and the item i2. Accordingly, the number-of-users (item i1, item i2) is one. As a result of similar aggregation, the number-of-users (item i1, item i3) is one, the number-of-users (item i1, item i4) is zero, and the number-of-users (item i1, item i5) is two.

In addition, the number-of-users (item i2, item i2) is one. In addition, the number-of-users (item i2, item i3) is zero, the number-of-users (item i2, item i4) is zero, and the number-of-users (item i2, item i5) is one. In addition, the number-of-users (item i3, item i3) is two, the number-of-users (item i3, item i4) is one, and the number-of-users (item i3, item i5) is two. Furthermore, the number-of-users (item i4, item i4) is three, the number-of-users (item i4, item i5) is one, and the number-of-users (item i5, item i5) is three.

Since the order of items forming a pair does not affect the summation of the number of users, the item-pair aggregation result 32 is a symmetric matrix. Accordingly, each of the aforementioned components takes the same value as the components with rows and columns interchanged. For example, the number-of-users (item i1, item i2), and the number-of-users (item i2, item i1) take the same value. The item-pair aggregation result 32 may be a triangular matrix with the upper triangular area or the lower triangular area omitted. In this case, zero is set to each of the components with rows and columns interchanged, except for the diagonal components.

Next, the server apparatus 100 generates a degree-of-similarity aggregation result 33 from the item-pair aggregation result 32. The degree-of-similarity aggregation result 33 is a symmetric matrix indicating the degree of similarity between two items, for a pair of items purchasable at the shopping site. The degree of similarity indicates the probability that the same user is interested in both of the two items, and the calculation method of FIG. 3 indicates the probability that the same user purchases both of the two items. Calculation of the degree of similarity may use the Tanimoto coefficient. For example, the degree of similarity between the item i1 and item i2 is represented using the Tanimoto coefficient as “number-of-users (item i1, item i2)+(the number-of-users (item i1, item i1)+the number-of-users (item i2, item i2)−the number-of-users (item i1, item i2))”. Calculation of the degree of similarity may also use other coefficients such as the Ochiai coefficient or the Sorensen coefficient.

Each row and each column of the degree-of-similarity aggregation result 33 represent the item purchasable at the shopping site. Each component of the degree-of-similarity aggregation result 33 represents the degree of similarity between two items. In the following, a component corresponding to a row and a column representing an item in the degree-of-similarity aggregation result 33 may be referred to as “degree-of-similarity (item (row), item (column))”. The degree of similarity is not calculated for a set of same items (diagonal components).

For example, the degree-of-similarity (item i1, item i2) is “1/(2+1−1)=½” as indicated by the degree-of-similarity aggregation result 33 of FIG. 3. As a result of similar aggregation, the degree-of-similarity (item i1, item i3) is ⅓, the degree-of-similarity (item i1, item i4) is zero, and the degree-of-similarity (item i1, item i5) is ⅔. In addition, the degree-of-similarity (item i2, item i3) is zero, the degree-of-similarity (item i2, item i4) is zero, and the degree-of-similarity (item i2, item i5) is ⅓. In addition, the degree-of-similarity (item i3, item i4) is ¼, and the degree-of-similarity (item i3, item i5) is ⅔. Furthermore, the degree-of-similarity (item i4, item i5) is ⅕.

Since the order of items forming a pair does not affect the calculation of the degree of similarity, the degree-of-similarity aggregation result 33 is a symmetric matrix. Accordingly, each of the aforementioned components takes the same value as the components with rows and columns interchanged. For example, the degree-of-similarity (item i1, item i2), and the degree-of-similarity (item i2, item i1) take the same value. The degree-of-similarity aggregation result 33 may be a triangular matrix with the upper triangular area or the lower triangular area omitted. In this case, zero is set to each of the components with rows and columns interchanged, except for the diagonal components.

The client apparatus 200 receives the degree-of-similarity aggregation result 33 from the server apparatus 100. When, for example, a user has logged into a shopping site, the client apparatus 200 identifies a recommended item as follows, based on the purchase history information of the user who has logged in and the received information indicating the degree-of-similarity aggregation result 33.

First, the client apparatus 200 identifies, for each item purchased in the past by the user who has logged into the shopping site, another item whose degree of similarity is larger than a threshold value (e.g., ½) as a recommended item. For example, let us assume that the user u5 who purchased the items i1, i2 and i5 in the past has logged in. In this case, the item i5 has a larger degree of similarity with the item i1 than the threshold value, as indicated by the degree-of-similarity aggregation result 33 of FIG. 3. In addition, there is no item having a larger degree of similarity with the item i2 than the threshold value, and the items i1 and i3 have a larger degree of similarity with the item i5 than the threshold value. Therefore, the client apparatus 200 identifies the item i3 which has not yet been purchased by the user u5 as a recommended item, for example. Information of each of the identified items is provided to the user. In this case, for example, information related to the item i3 is displayed on the Web page to be browsed by the user u5 after login.

In addition, the client apparatus 200 may identify another item having a high degree of similarity with the item being browsed by the user at the shopping site as a recommended item. In this case, information of the item recommended to the user is displayed on the same Web page together with, for example, the information of the item being browsed by the user.

The server apparatus 100 may identify an item to be recommended to the user. In this case, the client apparatus 200 transmits, to the server, information indicating the user who has logged in, or information indicating the item being browsed by the user. Based on the received information indicating the user or the information indicating the item, the server apparatus 100 then identifies an item to be recommended as described above, and transmits the information indicating the identified item to the client apparatus 200.

Here, the client apparatus 200 continuously generates purchase history information along with operation of the shopping site, even after the server apparatus 100 has performed the first-time analysis procedure. It is preferred that the server apparatus 100 provides the client apparatus 200 with the latest analysis result having reflected therein the newly generated purchase history information, in addition to the purchase history information used for the first-time analysis procedure. However, repeating the analysis procedure as a batch process such as described above causes duplicative analysis of the same purchase history information among a plurality of analysis procedures, which leaves room for improving the efficiency. Since the data which may be affected by the newly generated purchase history information is a small part of the data included in the analysis result, updating only the affected part increases the efficiency.

In the system of the second embodiment, therefore, the server apparatus 100 recalculates the degree of similarity not for pairs of all the items, but only for the pairs of items indicated by the newly received purchase history information and other items. In the following, the manner of performing the analysis procedure which updates only the analysis result related to the added or updated data to be analyzed may be referred to as an “incremental process”.

FIG. 4 illustrates an example of performing data analysis performed as an incremental process.

Having performed the first-time analysis procedure, the server apparatus 100 has stored therein the per-user aggregation result 31, the item-pair aggregation result 32, and the degree-of-similarity aggregation result 33. When purchase history information indicating that the user u4 has purchased the item i2 is added in this state, the server apparatus 100 updates the degree of similarity affected by the purchase history information added by the analysis procedure performed as an incremental process.

First, the server apparatus 100 updates the purchase-flag (user u4, item i2) with “∘” as indicated by the per-user aggregation result 31 of FIG. 4.

Next, the server apparatus 100 updates the item-pair aggregation result 32, based on the updated the purchase-flag (user u4, item i2). Of all the components of the item-pair aggregation result, the components which may be affected by the purchase-flag (user u4, item i2) are the number-of-users (item i2, items i1 to i5) and the number-of-users (items i1 to i5, item i2).

In addition, the item purchased before by the user u4 is the item i4, as indicated by the per-user aggregation result 31 of FIG. 4. Therefore, the server apparatus 100 updates the number-of-users (item i2, item i2), the number-of-users (item i2, item i4), and the number-of-users (item i4, item i2) out of the aforementioned components. In other words, because the user u4 purchased item i2, the number of users of the item pair is added (incremented) by one. As a result, the number-of-users (item i2, item i2) is updated from one to two, the number-of-users (item i2, item i4) is updated from zero to one, and the number-of-users (item i4, item i2) is updated from zero to one, as indicated by the item-pair aggregation result 32 of FIG. 4.

The server apparatus 100 then updates the degree-of-similarity aggregation result 33, based on the updated number-of-users (item i2, item i2), number-of-users (item i2, item i4), and number-of-users (item i4, item i2). Of all the components of the degree-of-similarity aggregation result 33, the components affected by the number-of-users (item i2, item i2) are the degree-of-similarity (item i2, items i1 to i5) and the degree-of-similarity (items i1 to i5, item i2). In addition, the components affected by the number-of-users (item i2, item i4) and the number-of-users (item i4, item i2) are also included in the aforementioned range.

Therefore the server apparatus 100 recalculates each of the aforementioned components out of all the components of the degree-of-similarity aggregation result 33. However, the number-of-users (item i2, item i3) and the number-of-users (item i3, item i2) are zero and therefore the numerators of the degree-of-similarity (item i2, item i3) and the degree-of-similarity (item i3, item i2) still being zero need not be recalculated. As a result, the degree-of-similarity (item i2, item i1) is updated from ½ to ⅓, the degree-of-similarity (item i2, item i4) is updated from zero to ¼, and the degree-of-similarity (item i2, item i5) is updated from ⅓ to ¼, as indicated by the degree-of-similarity aggregation result 33 of FIG. 4. In addition, the degree-of-similarity (item i1, item i2) is also updated to ⅓, the degree-of-similarity (item i4, item i2) is also updated to ¼, and the degree-of-similarity (item i5, item i2) is also updated to ¼.

Accordingly, the number of components of the matrix accessed by the server apparatus 100 when performing the analysis procedure as a batch process is “5×5+5×5+4×5=70”. On the other hand, the number of components of the matrix accessed by the server apparatus 100 when performing the analysis procedure performed as an incremental process is “1+3+6=10”. In other words, the number of components actually changed due to reception of the new purchase history information out of 70 components included in data such as an intermediate processing result or the analysis result is 10. Therefore performing the second-time or later analysis procedure as an incremental process reduces the number of components of the matrix to be updated. Therefore, the efficiency of analysis procedure increases.

Here, data (which may be referred to as analysis data, in the following) such as the purchase history information, the per-user aggregation result 31, the item-pair aggregation result 32, and the degree-of-similarity aggregation result 33 are stored in a nonvolatile storage device such as an HDD provided in the server apparatus 100.

When the server apparatus 100 performs the analysis procedure as a batch process, the analysis data may be preliminarily sorted in the order of being accessed by the analysis procedure and physically arranged on the HDD in the sorted order. Accordingly, the analysis data is allowed to be sequentially accessed when performing the analysis procedure, whereby the HDD may be accessed efficiently.

When performing the analysis procedure as an incremental process, however, which of the analysis data stored in the HDD will be accessed is unknown until purchase history information is newly received. Accordingly, it is difficult with an incremental process to preliminarily sort the analysis data in the HDD according to the order of reference or updating, whereby random access is likely to occur. Therefore, incremental processing leaves room for increasing the efficiency of accessing analysis data on the HDD in comparison with batch process.

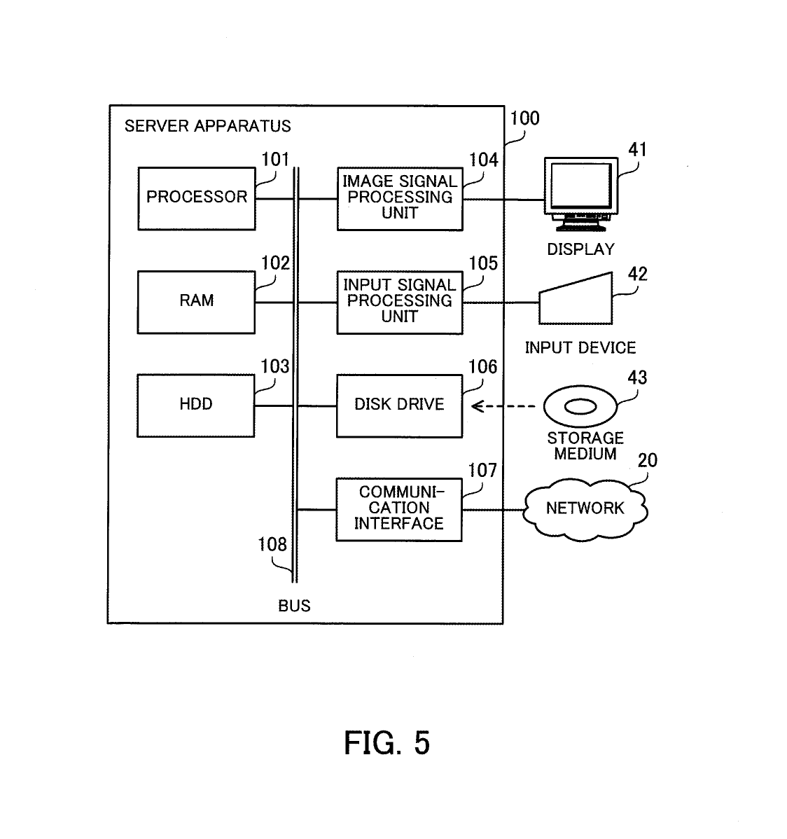

In FIGS. 5 to 14, there is described a method of suppressing random access to the HDD in the analysis procedure performed as an incremental process by the server apparatus 100.

FIG. 5 is a block diagram illustrating exemplary hardware of the server apparatus. The server apparatus 100 has a processor 101, a RAM 102, an HDD 103, an image signal processing unit 104, an input signal processing unit 105, a disk drive 106, and a communication interface 107. The units are connected to a bus 108 in the server apparatus 100. The processor 101 is an example of the operation unit 13 of the first embodiment. In addition, the RAM 102 is an example of the memory 12 of the first embodiment. In addition, the HDD 103 is an example of the storage device 11 of the first embodiment.

The processor 101, including an operation device which executes program instructions, is a CPU, for example. The processor 101 loads, to the RAM 102, at least a part of programs or data stored in the HDD 103 and executes the program. The processor 101 may include a plurality of processor cores. In addition, the server apparatus 100 may include a plurality of processors. In addition, the server apparatus 100 may perform parallel processing using the plurality of processors or the plurality of processor cores. In addition, a set of two or more processors, a dedicated circuit such as an FPGA or an ASIC, a set of two or more dedicated circuits, a combination of processors and dedicated circuits may be referred to as a “processor”.

The RAM 102 is a volatile memory configured to temporarily store a program to be executed by the processor 101 and data referred to from the program. The server apparatus 100 may include a memory in a type other than the RAM, and may include a plurality of volatile memories.

The HDD 103 is a nonvolatile storage device configured to store programs and data of software such as the OS (Operating System), firmware, and application software. The server apparatus 100 may include another type of storage device such as a flash memory, and may include a plurality of nonvolatile storage devices.

The image signal processing unit 104 outputs images to a display 41 connected to the server apparatus 100, according to an instruction from the processor 101. A CRT (Cathode Ray Tube) display, a liquid crystal display or the like may be used as the display 41.

The input signal processing unit 105 obtains input signals from an input device 42 connected to the server apparatus 100, and notifies the processor 101 of the signals. A pointing device such as a mouse or a touch panel, a keyboard or the like may be used as the input device 42.

The disk drive 106 is a drive device configured to read programs and data stored in the storage medium 43. A magnetic disk such as a flexible disk (FD) or an HDD, a optical disk such as a CD (Compact Disc) or a DVD (Digital Versatile Disc), or a Magneto-Optical disk (MO), for example, may be used as the storage medium 43. According to an instruction from the processor 101, the disk drive 106 stores, in the RAM 102 or the HDD 103, programs and data which have been read from the storage medium 43.

The communication interface 107 communicates with other information processing apparatuses (e.g., the client apparatus 200, etc.) via a network such as the network 20.

The server apparatus 100 need not be provided with the disk drive 106 and, when being solely controlled by another terminal device, may not be provided with the image signal processing unit 104 and the input signal processing unit 105. In addition, the display 41 and the input device 42 may be integrally formed with the housing of the server apparatus 100.

The client apparatus 200 may also be realized using similar hardware to the server apparatus 100.

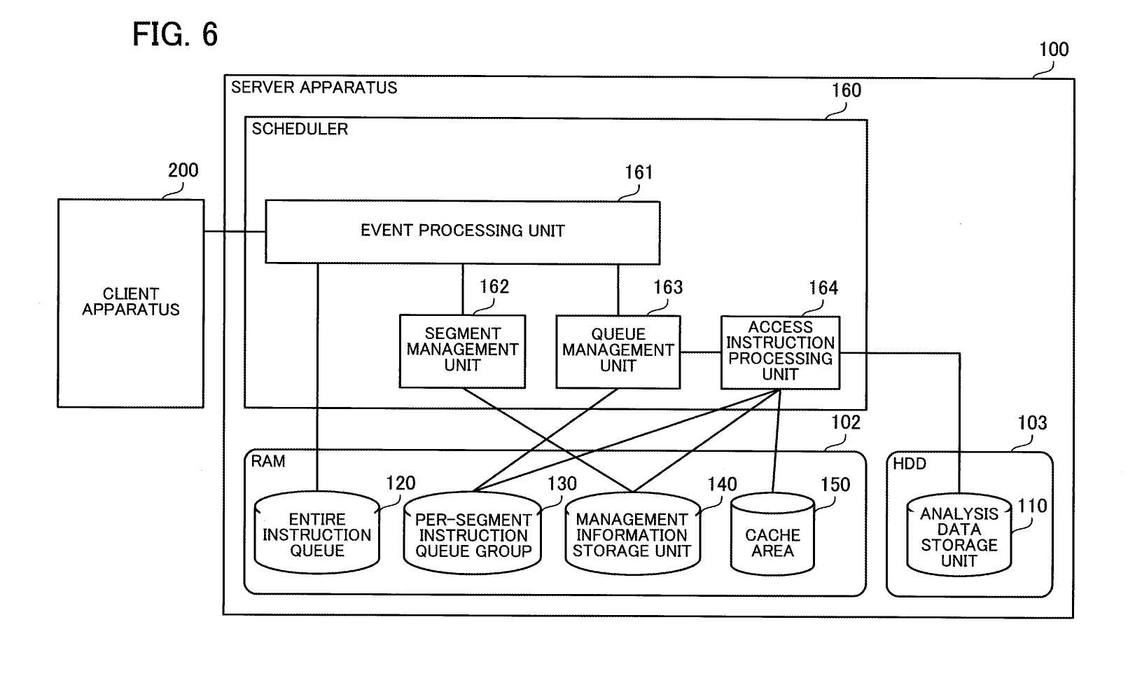

FIG. 6 is a block diagram illustrating an exemplary function of the server apparatus. The server apparatus 100 has an analysis data storage unit 110, an entire instruction queue 120, a per-segment instruction queue group 130, a management information storage unit 140, a cache area 150, and a scheduler 160. The analysis data storage unit 110 is realized as a storage area secured in the HDD 103. The entire instruction queue 120, the per-segment instruction queue group 130, the management information storage unit 140, and the cache area 150 are realized as a storage area secured in the RAM 102. The scheduler 160 is realized as a program module executed by the processor 101.

In addition, the per-segment instruction queue group 130 is an exemplary set of the areas 12a, 12b and 12c of the first embodiment. In addition, the cache area 150 is an example of the cache area 12d of the first embodiment.

The analysis data storage unit 110 stores analysis data used for the analysis procedure. The analysis data may include an analyzed target (e.g., purchase history information), an intermediate processing result (e.g., per-user aggregation result 31 and item-pair aggregation result 32), and an analysis result (e.g., degree-of-similarity aggregation result 33). The analysis data is referred to and updated according to an access instruction. In the system of the second embodiment, an access instruction may include obtaining analysis data, performing operations such as the four arithmetic operations specified by an access instruction for the obtained analysis data, and updating the analysis data with the operation result, which are represented as a single instruction. In other words, an access instruction includes an instruction accompanying one-time data input and output and operation. Other than an instruction accompanying operation as described above, the access instruction may be a simple instruction such as a read instruction or a write instruction, or a comparison instruction. In the system of the second embodiment, it is assumed that the result of a certain access instruction does not affect the result of other access instructions. In other words, a plurality of access instructions generated around the same time may be executed in any order.

Analysis data (a single “value”) of an access destination according to a single access instruction is identified by a key. The single value identified by a key may be a value representing a row of a matrix, or representing a component of a matrix, for example. Each of such keys is associated with one of a plurality of segments on the HDD 103. A segment is a storage area obtained by dividing a storage area on the HDD 103 into a predetermined data size. A value corresponding to a key is placed in a segment associated with the key among a plurality of segments. Although each segment is divided into the same capacity in the system of the second embodiment, it may be divided into different capacities.

When allocating the analysis data in a plurality of segments in a distributed manner, it is preferred to allocate analysis data which is likely to be continuously updated in the same segment. For example, with identification information of an item being the key, analysis data for an item in the same genre (value associated with the key of the item) is placed in the same segment.

The correspondence between a key and a segment may be arbitrarily determined by the administrator of the server apparatus 100, or may be automatically determined using statistic information related to the analysis data updated around the same time.

The entire instruction queue 120 is a queue for storing access instructions. The entire instruction queue 120 stores access instructions generated by the scheduler 160.

The per-segment instruction queue group 130 is a set of per-segment instruction queues. A per-segment instruction queue is a queue for storing access instructions, similarly to the entire instruction queue 120. A plurality of per-segment instruction queues has allocated thereto access instructions on the entire instruction queue 120 by the scheduler 160. In addition, segments in the per-segment instruction queues and the HDD 103 are associated with each other on a one-to-one basis. In addition, the plurality of per-segment instruction queues is arranged side-by-side in a storage area on the RAM 102 in an order corresponding to the physical order in which the segments are arranged on the HDD 103. In addition, each per-segment instruction queue has assigned thereto sequential identifiers (e.g., sequential ID numbers) in an order in which the segments are arranged on the RAM 102.

The management information storage unit 140 stores a key information table for storing information indicating the correspondence relation among the key of analysis data, the segment storing the analysis data, and the per-segment instruction queue. In addition, the management information storage unit 140 stores a cache management queue for managing a segment loaded (cached) on the cache area 150.

The cache area 150 is an area for caching the analysis data in some of all the segments on the HDD 103. “Caching” is meant to temporarily load data from the HDD 103 to the cache area 150. The cache area 150 has cached therein the entire segment including the analysis data that the scheduler 160 tries to access according to an access instruction.

The scheduler 160 performs a series of processes from reception of the purchase history information to execution of the access instruction. The scheduler 160 has an event processing unit 161, a segment management unit 162, a queue management unit 163, and an access instruction processing unit 164.

The event processing unit 161 receives purchase history information from the client apparatus 200. The event processing unit 161 analyzes the received purchase history information and generates an access instruction. One or more access instructions may be generated for a single piece of purchase history information. In addition, the event processing unit 161 may extract an access instruction by analyzing the received purchase history information using a predetermined application program. The event processing unit 161 stores the generated access instruction in the entire instruction queue 120.

In addition, the event processing unit 161 fetches an access instruction from the entire instruction queue 120. The event processing unit 161 then requests the segment management unit 162 to determine the per-segment instruction queue to which the fetched access instruction is to be allocated. In addition, the event processing unit 161 requests the queue management unit 163 to allocate the fetched access instructions to the per-segment instruction queue which has been determined to be the allocation destination of the access instruction.

In response to the request from the event processing unit 161, the segment management unit 162 determines the per-segment instruction queue to which the fetched access instruction is to be allocated, based on the information stored in the key information table. The per-segment instruction queue of the allocation destination is a per-segment instruction queue corresponding to the segment having stored therein analysis data of the access destination. The segment management unit 162 then outputs, to the event processing unit 161, information indicating the per-segment instruction queue which has been determined to be the allocation destination.

In response to the request from the event processing unit 161, the queue management unit 163 stores the access instruction in the per-segment instruction queue which has been determined to be the allocation destination. In addition, the queue management unit 163 monitors the number of input instructions of access instructions to the per-segment instruction queue per unit time (which may be referred to as number of input instructions per unit time, in the following). In addition, the queue management unit 163 outputs the monitored number of input instructions per unit time to the access instruction processing unit 164, in response to the request from the access instruction processing unit 164.

The access instruction processing unit 164 executes the access instruction in the per-segment instruction queues as follows. In the following, an execution procedure of each access instruction in the per-segment instruction queue may be referred to as an “access instruction execution procedure”.

First, the access instruction processing unit 164 selects one or more per-segment instruction queues, based on the number of access instructions in each of the per-segment instruction queues. The number of per-segment instruction queues to be selected is calculated by the access instruction processing unit 164, based on the number of input instructions per unit time which has been output from the queue management unit 163, and the number of output instructions per unit time. The “number of output instructions per unit time” refers to the number of access instructions per unit time expected to be output from the per-segment instruction queue (processed by the access instruction processing unit 164).

Next, the access instruction processing unit 164 caches the data of the segment corresponding to the selected per-segment instruction queue, based on the cache status of the segment indicated by the information in the cache management queue. On this occasion, when there is no vacant area for caching on the cache area 150, the data of the segment in the earliest (oldest) loaded cache area 150 is written back to the analysis data storage unit 110.

The access instruction processing unit 164 then collectively executes the access instructions in the selected per-segment instruction queue for the data of the cached segment.

In the system of the second embodiment, for example, each time an access instruction execution procedure for a per-segment instruction queue selected at the previous time is completed, another access instruction execution procedure is performed. When the frequency of generating an access instruction by the event processing unit 161 is relatively low, the access instruction execution procedure may be performed intermittently at a predetermined cycle.

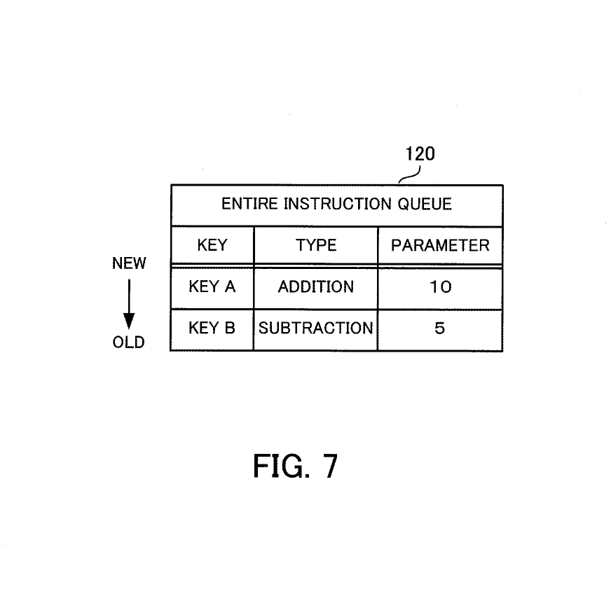

Next, the tables and queues used by the server apparatus 100 will be described, referring to FIGS. 7 to 9.

FIG. 7 illustrates an exemplary entire instruction queue. An entire instruction queue 120 is a queue for storing access instructions generated by the event processing unit 161. As illustrated in FIG. 7, access instructions stored in the entire instruction queue 120 are placed in a manner such that, older, i.e., earlier-stored access instructions are placed in lower slots whereas newer, i.e., later-stored access instructions are placed in higher slots. In the following, the same goes for the entire instruction queue 120 and per-segment instruction queues illustrated in other drawings.

For example, let us assume that access instructions have been generated in the order of an access instruction of subtracting five from the analysis data corresponding to key B (value identified by key B) followed by an access instruction of adding ten to the analysis data corresponding to key A. In this case, the access instruction with the key-field being “key B”, the type-field being “subtraction”, and the parameter-field being “5” is stored first, as indicated by the entire instruction queue 120 of FIG. 7. Subsequently, the access instruction with the key-field being “key A”, the type-field being “addition”, and the parameter-field being “10” is stored thereon. In this case, when fetching an access instruction from the entire instruction queue 120 of FIG. 7, access instructions are fetched in chronological order (the access instruction with the key-field being “key B” followed by the access instruction with the key-field being “key A”).

Access instructions stored in the entire instruction queue 120 have fields of key, type, and parameter. The same goes for access instructions in the per-segment instruction queue.

The key-field has set therein a key for identifying access destination analysis data. The type-field has set therein the type of access instruction. Included in the type of access instruction are: the four arithmetic operations, i.e., addition, subtraction, multiplication and division, or other types of operation. The parameter-field has set therein a parameter according to the type of access instruction (e.g., an operand of the operation used in combination with the current value such as addend, subtrahend, multiplier and divisor).

For example, when executing an access instruction with the key-field in the entire instruction queue 120 of FIG. 7 being “key A”, a process is performed which first reads analysis data corresponding to key A, and adds ten to the read-out analysis data. Next, analysis data corresponding to key A is updated according to the result of the addition process. When executing an access instruction with the key-field being “key B”, a process is performed which first reads analysis data corresponding to key B, and subtracts five from the read-out analysis data. Next, analysis data corresponding to key B is updated according to the result of the subtraction process.

Besides instructions of the four arithmetic operations, the type of access instruction may be a simple instruction such as a read instruction and a write instruction, or other instructions such as a comparison instruction.

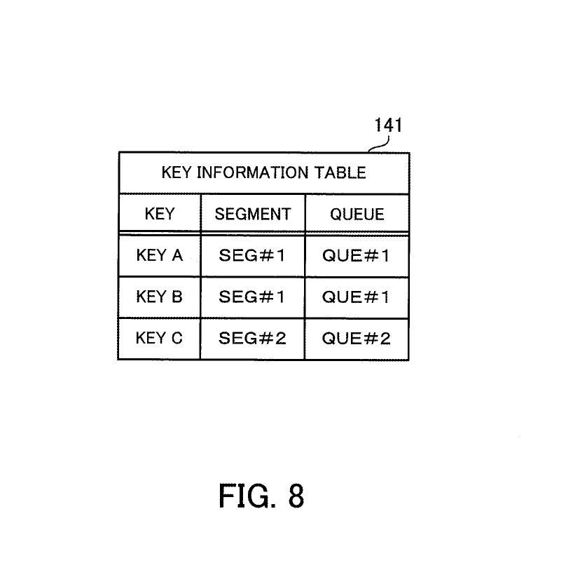

FIG. 8 illustrates an exemplary key information table. A key information table 141 stores information related to the key of analysis data stored in the analysis data storage unit 110. The key information table 141 is stored in the management information storage unit 140.

The key information table 141 has fields of key, segment and queue. The key-field has set therein a key for identifying analysis data. The segment-field has set therein an identifier of a segment having stored therein analysis data identified by a key. The queue-field has set therein an identifier of a per-segment instruction queue corresponding to a segment. Referring to the key information table 141, the segment management unit 162 may identify the per-segment instruction queues storing the access instruction from the key included in the access instruction.

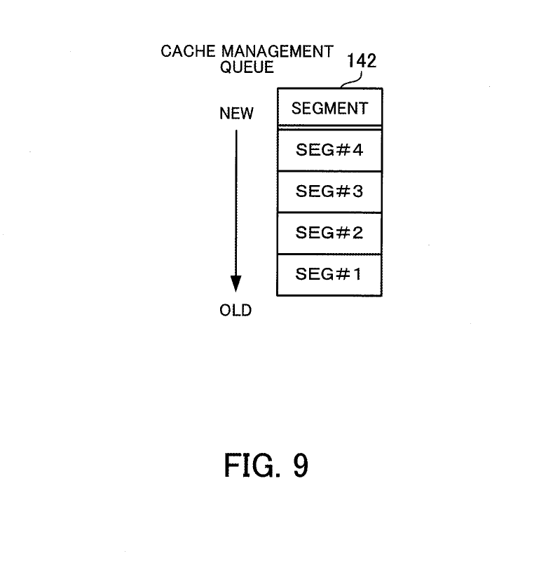

FIG. 9 illustrates an exemplary cache management queue. A cache management queue 142 stores information related to a segment which has been loaded (cached) on the cache area 150. As illustrated in FIG. 9, the information related to a segment stored in the cache management queue 142 is such that earlier-stored, i.e., older segments are placed in lower slots, whereas later-stored, i.e., newer segments are placed in higher slots. In the following, the same goes for the cache management queue 142 illustrated in other drawings.

The cache management queue 142 has a segment-field. The segment-field has set therein an identifier for identifying the segment in the cache area 150 in which analysis data is currently cached. When ejecting analysis data of a certain segment from the cache area 150, segments are selected in chronological order of the cached time. However, other cache algorithms may be used, such as the LRU (Least Recently Used) algorithm which takes into account the access status in the cache area 150.

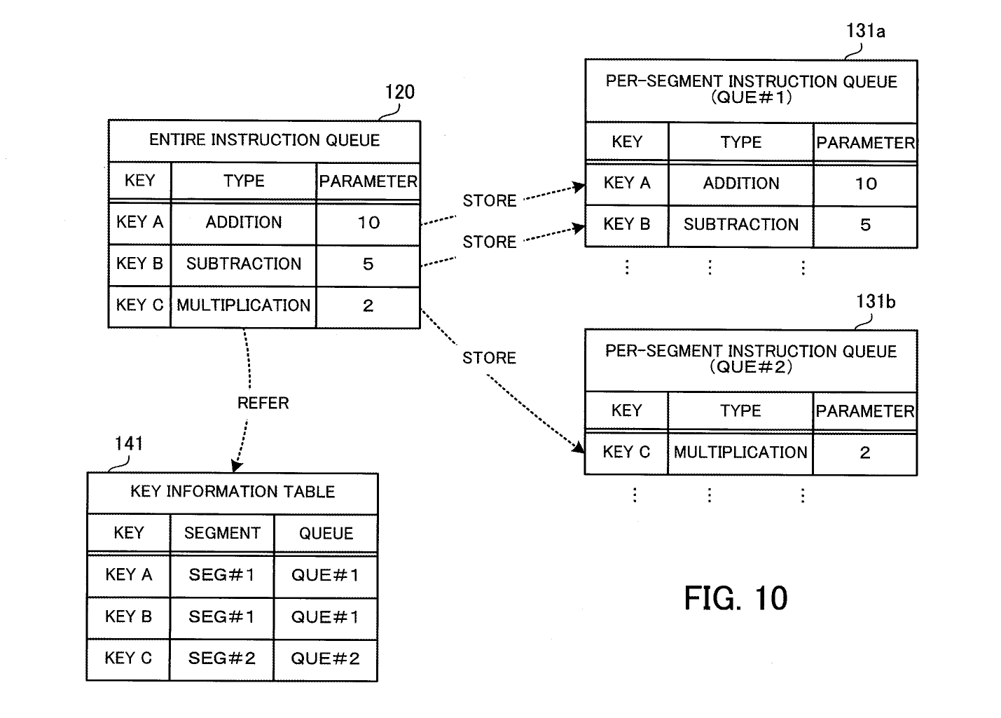

Next, each function of the server apparatus 100 will be described, referring to FIGS. 10 to 12.

FIG. 10 illustrates an example of allocating access instructions to per-segment instruction queues. In FIG. 10, an example of allocating access instructions stored in the entire instruction queue 120 to per-segment instruction queues 131a and 131b is described. The per-segment instruction queues 131a and 131b, included in the per-segment instruction queue group 130, correspond to segments SEG #1 and SEG #2 on the analysis data storage unit 110. The identifier of the per-segment instruction queue 131a is “QUE #1” and the identifier of the per-segment instruction queue 131b is “QUE #2”.

An access instruction stored in the entire instruction queue 120 is allocated by the scheduler 160 to a per-segment instruction queue associated with a key included in the access instruction. The correspondence relation between a key and a per-segment instruction queue is described in the key information table 141.

For example, a record exists in the key information table 141 having “key A” set in the key-field and “QUE #1” set in the queue-field. In addition, a record exists in the key information table 141 having “key B” set in the key-field and “QUE #1” set in the queue-field. Furthermore, a record exists in the key information table 141 having “key C” set in the key-field and “QUE #2” set in the queue-field.

In the above state, it is assumed that an access instruction having “key A” set in the key-field, an access instruction having “key B” set in the key-field, and an access instruction having “key C” set in the key-field are stored in the entire instruction queue 120.

In this case, since the queue corresponding to “key A” and “key B” is “QUE #1”, the access instruction having “key A” set therein and the access instruction having “key B” set therein are allocated in the per-segment instruction queue 131a. In addition, since the queue corresponding to “key C” is “QUE #2”, the access instruction having “key C” set therein is allocated in the per-segment instruction queue 131b by the scheduler 160.

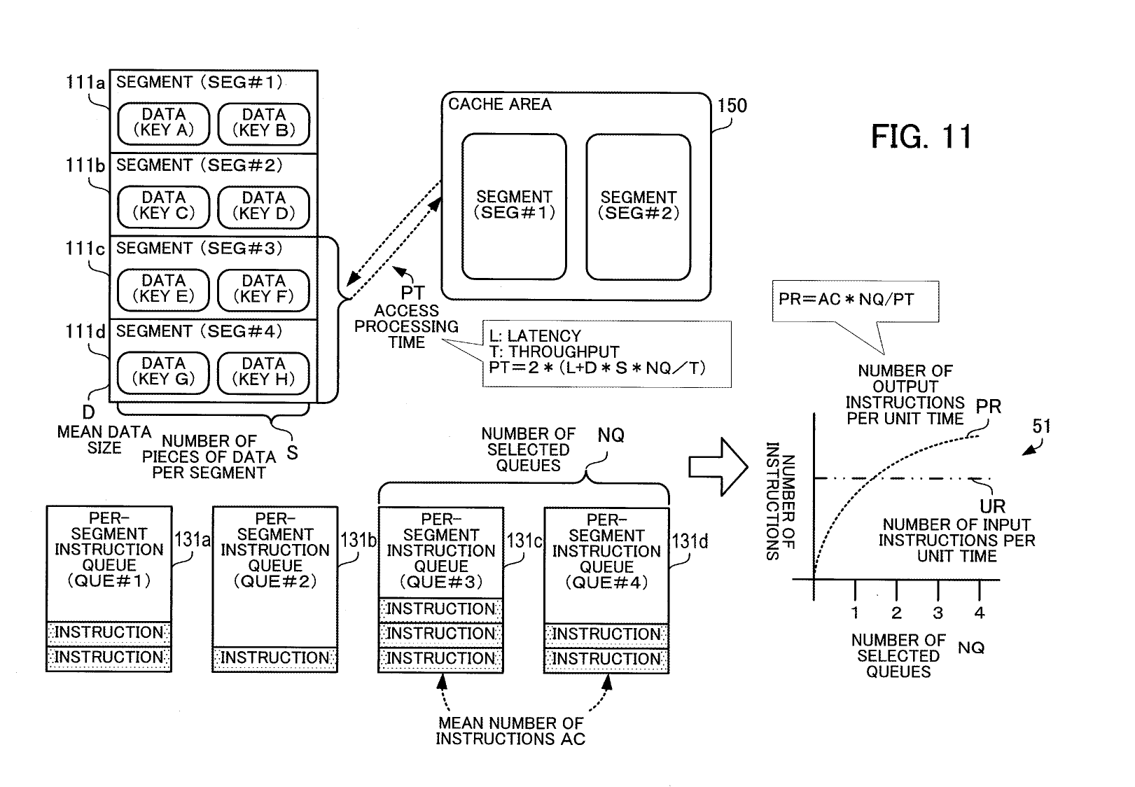

FIG. 11 illustrates an example of calculating the number of segments to be cached. The segments 111a, 111b, 111c and 111d are arranged sequentially in adjacent areas on the HDD 103. In other words, the segment 111a is adjacent to the segment 111b, the segment 111b is adjacent to the segment 111c, and the segment 111c is adjacent to the segment 111d. The identifier of the segment 111a is “SEG #1”, and the identifier of the segment 111b is “SEG #2”. In addition, the identifier of the segment 111c is “SEG #3” and the identifier of the segment 111d is “SEG #4”. In addition, the segment 111a has analysis data corresponding to “key A” and “key B” placed therein. In addition, the segment 111b has analysis data corresponding to “key C” and “key D” placed therein. In addition, the segment 111c has analysis data corresponding to “key E” and “key F” placed therein. In addition, the segment 111d has analysis data corresponding to “key G” and “key H” placed therein.

In addition, the cache area 150 has loaded therein analysis data of the segments 111a and 111b. In addition, the per-segment instruction queue group 130 includes the per-segment instruction queues 131a to 131d. The identifier of the per-segment instruction queue 131c is QUE #3″ and the identifier of the per-segment instruction queue 131d is “QUE #4”.

In addition, the per-segment instruction queue 131a has two access instructions stored therein, and the per-segment instruction queue 131b has one access instruction stored therein. The per-segment instruction queue 131c has three access instructions stored therein, and the per-segment instruction queue 131d has two access instructions stored therein.

In addition, the per-segment instruction queue 131a corresponds to the segment 111a, and the per-segment instruction queue 131b corresponds to the segment 111b. The per-segment instruction queue 131c corresponds to the segment 111c, and the per-segment instruction queue 131d corresponds to the segment 111d.

In addition, the per-segment instruction queues 131a, 131b, 131c and 131d may be arranged side-by-side on the RAM 102, or may be arranged in an arbitrary order. In addition, the order of arrangement of the per-segment instruction queues 131a, 131b, 131c and 131d may correspond to the segments 111a, 111b, 111c and 111d, or may be an arbitrary order.

On this occasion, the access instruction processing unit 164 calculates the number of output instructions per unit time PR as follows.

First, the access instruction processing unit 164 calculates an access processing time PT for analysis data of a segment on the HDD 103. The access processing time PT is a sum of the time taken to cache data of a specified number of segments on the HDD 103 and time taken to write the data of the cached segments back to the HDD 103. Specifically, the access processing time PT is calculated by “(latency L+mean data size D×number of pieces of data per segment S×number of selected queues NQ/throughput T)×2”.

The latency L is the delay time from when an access instruction to analysis data on the HDD 103 is requested to when access to the analysis data on the HDD 103 is started. The latency L includes, for example, seek time of a head in the HDD 103, disk rotation wait time, and the like.

The mean data size D is the mean value of sizes of respective analysis data units (each representing a single “value”) identified by a single key in the analysis data storage unit 110. In FIG. 11, for example, the mean data size D is the mean value of the sizes of data (keys A to H). Here, “data (keys A to H)” refers to the analysis data corresponding to the keys A to H.

The number of pieces of data per segment S is the mean value of the number of keys contained in a segment. As illustrated in FIG. 11, for example, each of the segments 111a, 111b, 111c and 111d has placed therein two sets of data each corresponding to a key, and therefore the number of pieces of data per segment S is two.

The number of selected queues NQ is the number of per-segment instruction queues to be selected at a time when the access instruction processing unit 164 executes the accumulated access instructions. The access instruction processing unit 164 calculates the access processing time PT assuming that the number of selected queues NQ is variable. As illustrated in FIG. 11, for example, the number of per-segment instruction queues included in the per-segment instruction queue group 130 is four and therefore the access processing time PT is calculated for each of the cases where the values of the number of selected queues NQ are “1” to “4”.

The throughput T is the amount of data per unit time which may be read from and written to the HDD 103.

In the system of the second embodiment, a fixed value preliminarily specified by the user (predicted value or expected value) may be used as the mean data size D and the number of pieces of data per segment S. In addition, a value calculated by the scheduler 160 by monitoring the HDD 103 (actual measurement value) may be used as the mean data size D and the number of pieces of data per segment S.

Next, the access instruction processing unit 164 calculates the number of output instructions per unit time PR. The number of output instructions per unit time PR is calculated by “mean number of instructions AC×number of selected queues NQ/access processing time PT”.

On this occasion, the number of output instructions per unit time PR is calculated for each of the calculated access processing times PT. In addition, the value used when calculating the access processing time PT is used as the number of selected queues NQ.

The mean number of instructions AC is the mean value of the number of access instructions for each per-segment instruction queue which has been output for each access instruction execution procedure of the past. The mean number of instructions AC may be calculated by, for example, monitoring the number of executed access instructions for each per-segment instruction queue selected when performing the access instruction execution procedure (number of access instructions which had been accumulated when the per-segment instruction queue was selected), and obtaining the moving average of the number of access instructions monitored during a predetermined period.

As thus described, the number of output instructions per unit time PR is calculated for the number of selected queues NQ of each queue as indicated by graph 51. Specifically, the number of output instructions per unit time PR monotonically increases as the value of the number of selected queues NQ increases. This is because the proportion of the latency L in the access processing time PT decreases as the amount of analysis data which may be sequentially read or written at a time increases. However, as the number of selected queues NQ becomes larger, the gradient (differential value) gradually decreases.

Next, the access instruction processing unit 164 extracts the number of selected queues NQ of queues whose number of output instructions per unit time PR is equal to or larger than the number of input instructions per unit time UR. Since the number of selected queues NQ of queues whose number of output instructions per unit time PR is equal to or larger than the number of input instructions per unit time UR is two to four, as indicated by graph 51, the number of selected queues NQ in the range of two to four is extracted.

The access instruction processing unit 164 then calculates the smallest value among the extracted number of selected queues NQ as the number of per-segment instruction queues to be selected by the access instruction processing unit 164. In FIG. 11, therefore, two is calculated as the number of queues to be selected by the access instruction processing unit 164.

When executing the accumulated access instructions, the access instruction processing unit 164 selects, from among the per-segment instruction queues 131a, 131b, 131c and 131d, NQ adjacent per-segment instruction queues at a time. For example, the access instruction processing unit 164 selects the pair of the per-segment instruction queues 131a and 131b, the pair of the per-segment instruction queues 131b and 131c, or the pair of the per-segment instruction queues 131c and 131d at a time. Subsequently, in the case where the cache area 150 overflows when the selected NQ segments are read into the cache area 150, the access instruction processing unit 164 writes the NQ segments back to the HDD 130 from the cache area 150. The NQ segments to be written back are selected from the cache management queue in chronological order. Subsequently, NQ adjacent segments among the segments 111a, 111b, 111c and 111d are sequentially read into the cache area 150. Selecting a plurality of adjacent per-segment instruction queues realizes access to a plurality of segments by a one-time sequential access, whereby effect of the latency L may be reduced.

As thus described, determining the number of per-segment instruction queues to be selected at a time so that PR≧UR holds prevents the per-segment instruction queues 131a, 131b, 131c and 131d from overflowing even when the load of the server apparatus 100 is high. In addition, making the number of per-segment instruction queues to be selected at a time as small as possible may shorten the cycle of selecting another per-segment instruction queue next. Therefore, it is possible to flexibly cope with the change of the non-uniformity of the number of access instructions accumulated in the per-segment instruction queues 131a, 131b, 131c and 131d. In addition, the smaller the number of per-segment instruction queues to be selected at a time is, the simpler the process of selecting a per-segment instruction queue to be processed next becomes.

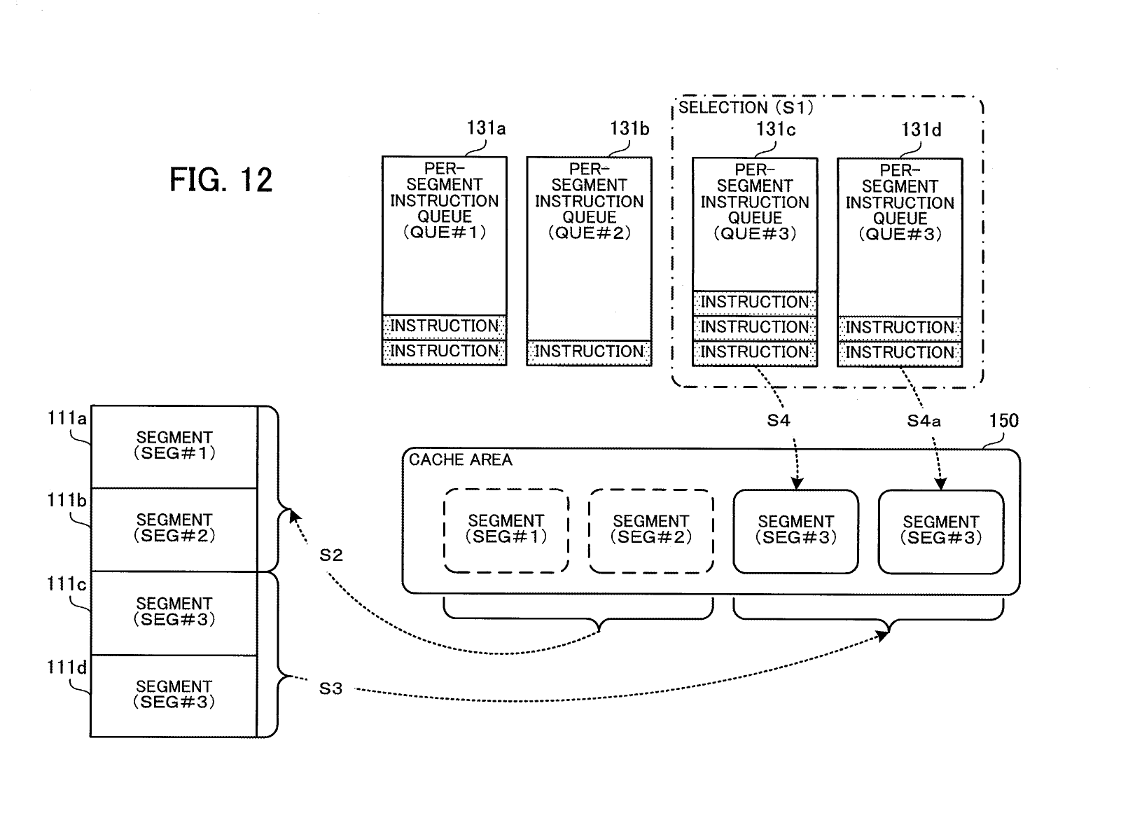

FIG. 12 illustrates an example of executing an access instruction. In FIG. 12, there is described an exemplary procedure of executing each access instruction stored in the per-segment instruction queues for the analysis data of the cached segment. In FIG. 12, description of components which are similar to those in FIG. 11 may be omitted. In addition, it is assumed that the access instruction processing unit 164 has calculated two as the number of per-segment instruction queues to be selected.

In the following, the procedure illustrated in FIG. 12 will be described along with step numbers.

(S1) The access instruction processing unit 164 selects as many per-segment instruction queues as the calculated number as follows.

For example, the access instruction processing unit 164 first calculates a combination of selectable per-segment instruction queues. On this occasion, the access instruction processing unit 164 calculates the combination so that a plurality of segments corresponding to the selected per-segment instruction queues is adjacent areas on the HDD 103. In FIG. 12, for example, the segments are arranged in adjacent areas on the HDD 103 in the order of segments 111a, 111b, 111c and 111d. Therefore a combination of the per-segment instruction queues 131a and 131b, a combination of the per-segment instruction queues 131b and 131c, and a combination of the per-segment instruction queues 131c and 131d are calculated.

Next, the access instruction processing unit 164 calculates, for each calculated combination, the total of the number of access instructions in each per-segment instruction queue included in the combination. The access instruction processing unit 164 then selects per-segment instruction queues included in the combination whose calculated total is the maximum. In FIG. 12, for example, the total number of access instructions in the per-segment instruction queues 131a and 131b is “2+1=3”. The total number of access instructions in the per-segment instruction queues 131b and 131c is “1+3=4”. The total number of access instructions in the per-segment instruction queues 131c and 131d is “3+2=5”. Therefore, the combination of the per-segment instruction queues 131c and 131d is selected by the access instruction processing unit 164.

(S2) The access instruction processing unit 164 determines whether or not there exists a vacant area in the cache area 150 for caching the segments 111c and 111d corresponding to the selected per-segment instruction queues 131c and 131d. In FIG. 12, since there is no vacant area in the cache area 150, it is determined that loading is impossible. Therefore, the access instruction processing unit 164 writes the analysis data of the segments 111a and 111b currently being cached back to the HDD 103.

On this occasion, since the segments 111a, 111b are arranged in adjacent areas on the HDD 103, it is possible to write the analysis data for two segments back to the HDD 103 by sequential access.

(S3) The access instruction processing unit 164 caches analysis data of the segment 111c corresponding to the per-segment instruction queue 131c and the segment 111d corresponding to the per-segment instruction queue 131d. On this occasion, the access instruction processing unit 164 may read the analysis data for the two segments by sequential access.

(S4, S4a) The access instruction processing unit 164 fetches the access instruction stored in each of the selected per-segment instruction queues 131c and 131d. The access instruction processing unit 164 then executes the fetched access instruction for the analysis data of the segments 111c and 111d which have been cached in the cache area 150.

It is assumed in the following description that the number of per-segment instruction queues calculated by the method described in FIG. 11 is two. It is also assumed that the number of segments which may be stored in the cache area 150 is a multiple of two. It turns out that respective segments on the cache area 150 will be written back to the HDD 103 in the same combination as when they were cached.

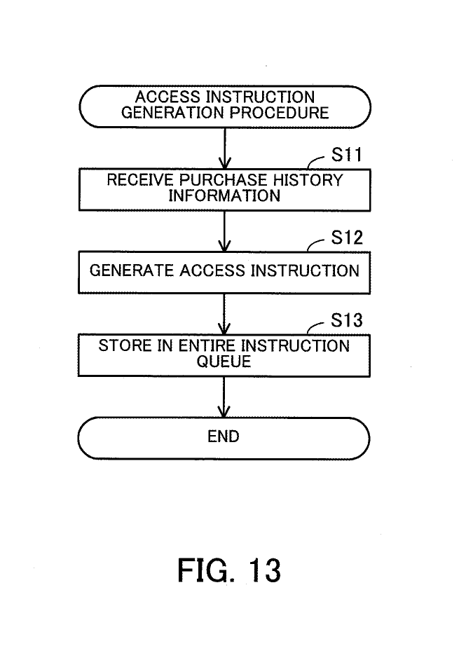

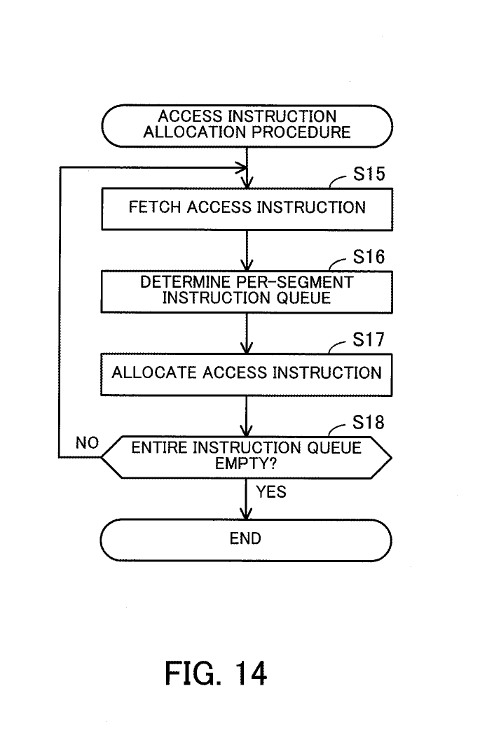

Next, a procedure regarding an access instruction by the scheduler 160 will be described using a flowchart, referring to FIGS. 13 to 14.

FIG. 13 is a flowchart illustrating an exemplary procedure of generating an access instruction. The procedure of FIG. 13 is performed when the event processing unit 161 received purchase history information from the client apparatus 200. In the following, the procedure illustrated in FIG. 13 will be described along with step numbers.

(S11) The event processing unit 161 receives purchase history information from the client apparatus 200.

(S12) Based on the received purchase history information, the event processing unit 161 generates one or more access instructions to the analysis data in the analysis data storage unit 110 by performing the analysis procedure as illustrated in FIG. 4. Each access instruction includes a key for identifying analysis data to be accessed.

(S13) The event processing unit 161 stores the one or more generated access instructions in the entire instruction queue 120.

FIG. 14 is a flowchart illustrating an exemplary procedure of allocating access instructions. The procedure of FIG. 14 is performed by the scheduler 160 at a constant cycle. In the following, the procedure illustrated in FIG. 14 is described along with step numbers.

(S15) The event processing unit 161 fetches an access instruction stored in the entire instruction queue 120.

(S16) The segment management unit 162 determines the per-segment instruction queue to be the allocation destination of the fetched access instruction as follows.

First, the segment management unit 162 retrieves, from the key information table 141, a record including the same key as that of the access instruction. Next, the segment management unit 162 determines the per-segment instruction queue described in the queue-field of the retrieved record as the per-segment instruction queue to be the allocation destination.

(S17) The queue management unit 163 stores the fetched access instruction in the determined per-segment instruction queue.

On this occasion, the queue management unit 163 monitors the number of access instructions stored in the per-segment instruction queue, and calculates the number of input instructions per unit time UR. For example, the number of input instructions per unit time UR is stored in a storage area secured in the management information storage unit 140.

(S18) The access instruction processing unit 164 determines whether or not the entire instruction queue 120 is empty. When the entire instruction queue 120 is empty, the procedure is terminated. When there exists an access instruction in the entire instruction queue 120, the process flow proceeds to step S15.

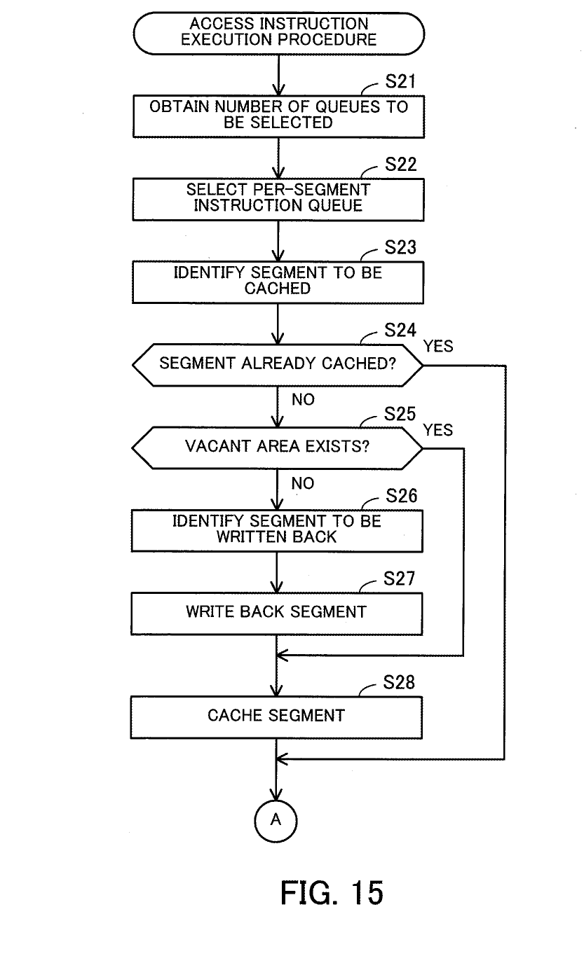

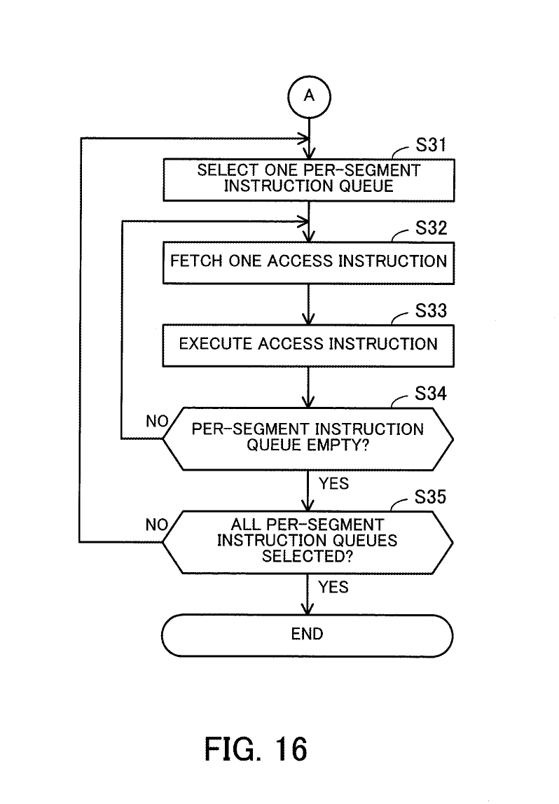

FIG. 15 is a flowchart illustrating an exemplary procedure of executing an access instruction. The access instruction procedure described in FIGS. 15 to 16 is performed, triggered by termination of the previous access instruction procedure. When the frequency of access instructions being stored in the entire instruction queue 120 is low, the procedure may be performed intermittently at a constant cycle. The procedure illustrated in FIGS. 15 to 16 will be described along with step numbers.

(S21) The access instruction processing unit 164 calculates the minimum value among the number of selected queues NQ satisfying “number of input instructions per unit time UR number of output instructions per unit time PR”, as described in FIG. 11. The access instruction processing unit 164 sets the calculated value as the number of per-segment instruction queues to be selected at step S22. On this occasion, the number of input instructions per unit time UR calculated by the queue management unit 163 at step S17 of FIG. 14 is used.

The number of per-segment instruction queues to be selected may be calculated each time the access instruction procedure of FIG. 15 is performed (each time one or more per-segment instruction queues are selected), or may be calculated intermittently. In addition, the number of input instructions per unit time UR used to determine the number of per-segment instruction queues may be newly obtained from the queue management unit 163 each time the determination is made, or may be obtained from the queue management unit 163 intermittently.

(S22) As described at step S1 of FIG. 12, the access instruction processing unit 164 selects, from the per-segment instruction queue group 130, as many per-segment instruction queues as the number calculated at step S21, in the following manner.

First, the access instruction processing unit 164 calculates combinations of selectable per-segment instruction queues. On this occasion, the calculation is performed so that segments corresponding to per-segment instruction queues included in each combination are placed in adjacent areas on the HDD 103. Whether two or more segments are adjacent may be determined according to, for example, whether or not identifiers of the segments or identifiers of per-segment instruction queues corresponding to the segments have sequential values. For example, “QUE #1” and “QUE #2” are determined to have sequential identifiers. Alternatively, “QUE #1” and “QUE #3” are determined to have non-sequential identifiers.

Next, the access instruction processing unit 164 calculates, for each calculated combination, the total numbers of access instructions in the per-segment instruction queues included in the combination. The access instruction processing unit 164 then selects a per-segment instruction queue of a combination whose calculated total is the maximum as the per-segment instruction queue from which an access instruction is to be fetched.

(S23) The access instruction processing unit 164 identifies the segment to be cached as follows. First, the access instruction processing unit 164 retrieves, for each per-segment instruction queue selected at step S22, a record including the identifier from the key information table 141. The access instruction processing unit 164 reads the identifier of the segment from the segment-field of the retrieved record. The access instruction processing unit 164 then identifies the segment indicated by the read-out identifier as the segment to be cached.

(S24) The access instruction processing unit 164 determines whether or not all the segments identified at step S23 have already been cached. Whether or not they have already been cached is determined according to whether or not identifiers of identified segments have been stored in the cache management queue 142.

When all the identified segments have already been cached, the process flow proceeds to step S31. When there exists a segment which has not been cached, the process flow proceeds to step S25.

(S25) The access instruction processing unit 164 determines whether or not there exists a vacant area for caching the analysis data of the identified segment in the cache area 150. In the following, the vacant area for caching may be referred to as a “vacant cache area”.

For example, the access instruction processing unit 164 calculates the number of segments additionally cacheable by subtracting the number of identifiers currently stored in the cache management queue 142 from the number of identifiers storable in the cache management queue 142. When the number of cacheable segments is equal to or larger than the number of segments identified at step S23, the access instruction processing unit 164 determines that there exists a vacant cache area for caching the analysis data of the identified segment.

When there exists a vacant cache area for the identified segment, the process flow proceeds to step S28. When there is no vacant cache area for the plurality of identified segments (when short of vacant cache areas), the process flow proceeds to step S26.

(S26) The access instruction processing unit 164 identifies a segment to be written back to the analysis data storage unit 110, among the segments which have been cached.

Specifically, as many identifiers of segments as the number calculated at step S21 are fetched from the top of the cache management queue 142 (lower part of FIG. 9). The access instruction processing unit 164 identifies the segment indicated by the fetched identifier as the segment whose analysis data is to be written back to the analysis data storage unit 110.

(S27) The access instruction processing unit 164 writes the analysis data of the segment on the cache area 150 identified at step S26 back to the analysis data storage unit 110 of the HDD 103. Even when there are two or more segments to be written back on this occasion, the two or more segments are adjacent to each other on the HDD 103 and therefore the analysis data of the two or more segments may be written back by a single sequential access.

(S28) The access instruction processing unit 164 stores the identifiers of the segments identified at step S23 to the cache management queue 142. On this occasion, the identifiers are stored in the cache management queue 142 in the order of placement of the segments.

The access instruction processing unit 164 then caches the analysis data of the identified segment in the cache area 150 from the analysis data storage unit 110 of the HDD 103.

FIG. 16 is a flowchart illustrating an exemplary procedure of executing an access instruction (continued).

(S31) The access instruction processing unit 164 selects one of the per-segment instruction queues selected at step S22 to be processed this time.

(S32) The access instruction processing unit 164 fetches one access instruction from the selected per-segment instruction queue.

(S33) The access instruction processing unit 164 executes the fetched access instruction for the analysis data of the segment on the cache area 150. The segment used is the segment corresponding to the per-segment instruction queue from which the access instruction has been fetched.

(S34) The access instruction processing unit 164 determines whether or not the per-segment instruction queue selected at step S31 is empty. In other words, the access instruction processing unit 164 determines whether or not all the access instructions have been fetched from the selected per-segment instruction queue.

When the per-segment instruction queue is empty, the process flow proceeds to step S35. When there exists an access instruction in the per-segment instruction queue, the process flow proceeds to step S32.

(S35) The access instruction processing unit 164 determines whether or not all the per-segment instructions selected at step S22 to be processed this time have already been selected. When all the per-segment instruction queues have already been selected, the process is terminated. When there exists an unselected per-segment instruction queue, the process flow proceeds to step S31.

According to the server apparatus 100 of the second embodiment, the entire analysis data of one or two or more segments are collectively cached in the RAM 102, and access instructions accumulated in the per-segment instruction queue are collectively performed for the cached analysis data. In addition, the entire analysis data of one or two or more segments are written back to the HDD 103 from the RAM 102. In other words, random access accompanied with execution of a plurality of access instructions is generated on the RAM 102 to which random access is relatively fast instead of being generated on the HDD 103 to which random access is relatively slow. On the HDD 103, sequential access is performed in place of random access. Accordingly, a plurality of access instructions may be executed efficiently. Particularly, a complicated access instruction such as reading the current value, performing an operation, and updating the value according to the operation result may be efficiently executed on the RAM 102.

In addition, when caching analysis data of a plurality of segments at a time, the analysis data of the plurality of segments may be read in a single sequential access by selecting adjacent segments on the HDD 103, allowing access in the HDD 103 to be performed efficiently.

In addition, the number of per-segment instruction queues processed at a time may be variable. When there are a large number of access instructions processed per unit time, increasing the numbers of per-segment instruction queues processed at a time makes it possible to reduce the effect of latency of the HDD 103 such as seek time and increase the number of access instructions that may be processed per unit time. Alternatively, when there are a small number of access instructions generated per unit time, reducing the number of per-segment instruction queues processed at a time makes it possible to shorten the cycle of selecting per-segment instruction queues. Accordingly, it becomes possible to flexibly cope with the change of generation status of access instructions, and also reduce the probability of unprocessed old access instructions staying in a certain per-segment instruction queue for a long time.

As has been described above, information processing of the first embodiment may be realized by causing the information processing apparatus 10 to execute programs, and information processing of the second embodiment may be realized by causing the server apparatus 100 and the client apparatus 200 to execute programs. Such programs may be stored in a computer-readable storage medium (e.g., storage medium 43). For example, a magnetic disk, an optical disk, an MO disk, a semiconductor memory, or the like may be used as the storage medium. The magnetic disk includes an FD and an HDD. The optical disk includes a CD, a CD-R (Recordable)/RW (Rewritable), a DVD and DVD-R/RW, or the like.

When distributing a program, a portable storage medium having stored the program is provided, for example. For example, a computer stores, in a storage device (e.g., the HDD 103), the program stored in the portable storage medium, reads the program from the storage device and executes it. However, a program read from the portable storage medium may be directly executed. In addition, at least a part of the information processing may be realized by an electronic circuit such as a DSP, an ASIC, a PLD (Programmable Logic Device), or the like.

In one aspect, the efficiency of accessing data stored in a storage device increases.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus comprising:
a storage device including a plurality of segments configured to store data;
a memory including a plurality of areas corresponding to the plurality of segments; and
a processor configured to process a plurality of generated access instructions, the processor being configured to:
store each of the generated access instructions in an area corresponding to a segment of an access destination of the each access instruction among the plurality of areas on the memory; and
load data of a segment corresponding to at least one area selected from the plurality of areas on the memory from the storage device to another area which is different from the plurality of areas on the memory, and execute the access instruction stored in the selected area, for the loaded data.

2. The information processing apparatus according to claim 1, wherein the processor
monitors a number of access instructions being generated per unit time, and
determines a number of areas to be selected at a time among the plurality of areas, according to the number of access instructions being generated per unit time.

3. The information processing apparatus according to claim 2, wherein the processor increases the number of areas to be selected at a time, according to increase of the number of access instructions being generated per unit time.

4. The information processing apparatus according to claim 1, wherein the processor, when selecting two or more areas at a time from the plurality of areas, sets the two or more areas selected, as areas corresponding to two or more segments adjacently arranged on the storage device.

5. The information processing apparatus according to claim 1, wherein the plurality of generated access instructions includes an access instruction of performing operation using data stored in one of the plurality of segments and rewriting the data according to a result of the operation.

6. A data access method comprising:
securing a plurality of areas in a memory provided in a computer, corresponding to a plurality of segments configured to store data included in a storage device provided in the computer;
storing, by a processor, each of a plurality of generated access instructions in an area corresponding to a segment of an access destination of the each access instruction among the plurality of areas; and
loading, by the processor, data of a segment corresponding to at least one area selected from the plurality of areas on the memory from the storage device to another area which is different from the plurality of areas on the memory, and executing the access instruction stored in the selected area, for the loaded data.

7. A non-transitory computer-readable storage medium storing a computer program that causes a computer to execute a process comprising:
securing a plurality of areas in a memory provided in the computer, corresponding to a plurality of segments configured to store data included in a storage device provided in the computer;
storing each of a plurality of generated access instructions in an area corresponding to a segment of an access destination of the each access instruction among the plurality of areas; and
loading data of a segment corresponding to at least one area selected from the plurality of areas on the memory from the storage device to another area which is different from the plurality of areas on the memory, and executing the access instruction stored in the selected area, for the loaded data.
